(19) United States
(12) Patent Application Publication
(10) Pub. No.: US 2006/0050478 A1
(43) Pub. Date: Mar. 9, 2006

(54) Slim type optical storage drive for notebook computer

(75) Inventors: Cheng-Pu Chu, Tucheng City (TW); Jung-Wen Chang, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/122,134

(22) Filed: May 4, 2005

(30) Foreign Application Priority Data
Sep. 3, 2004 (TW) 93126662

(51) Int. Cl. G06F 1/16

(52) U.S. Cl. 361/684

(57) ABSTRACT

The invention provides a slim type optical storage drive for use in notebook computers. The inventive drive has no housing and is thereby slimmer than a conventional drive. The core of the drive comprises a control circuit board, a tray and a fixing portion for fixing the drive in a notebook computer. The core of the drive, while disposed in the notebook computer, is protected by the notebook computer rather than a housing. A notebook computer, provided with a slim type optical storage drive of the invention, is lighter, slimmer, and less expensive.

### BACKGROUND

The present invention relates in general to a slim type optical storage drive and in particular to a slim type optical storage drive for a notebook computer.

Referring to FIG. 1, a conventional optical storage drive 10 of a notebook computer is manufactured by the manufacturer of the optical storage drive, and then transmitted to the manufacturer of the notebook computer who fits the optical storage drive to the notebook computer. The conventional optical storage drive 10 comprises a core and a housing 11 for protecting the core. Installing the housing around the core of the drive 10 increases the thickness and the weight of the notebook computer.

Notebook computers are highly valued not only for their functionality but also their portability. Hence a thin, lightweight notebook computer is desirable.

### SUMMARY

Accordingly, the invention provides a notebook computer with a slim type optical storage drive consisting essentially of a core. The core connects to the notebook computer via a control circuit board for driving the optical storage drive. A tray over the control circuit board supports a disc. A fixing portion connects the core and the notebook computer when the core is disposed in a space. The space comprises at least a closed side and an open side situated on the base. The core is installed in the space and is protected via the closed side of the space.

The housing of the conventional optical storage drive is replaced by the closed side of the space for protecting the core. Reducing the conventional housing can decrease the thickness and weight of the notebook computer. Decreasing the thickness and weight of the notebook computer is convenient to carry for a user and reduces the cost.

### BRIEF DESCRIPTION OF THE DRAWINGS

The present invention can be more fully understood by reading the subsequent detailed description and examples with references made to the accompanying drawings, wherein:

FIG. 1 is a schematic structure of a conventional notebook computer;

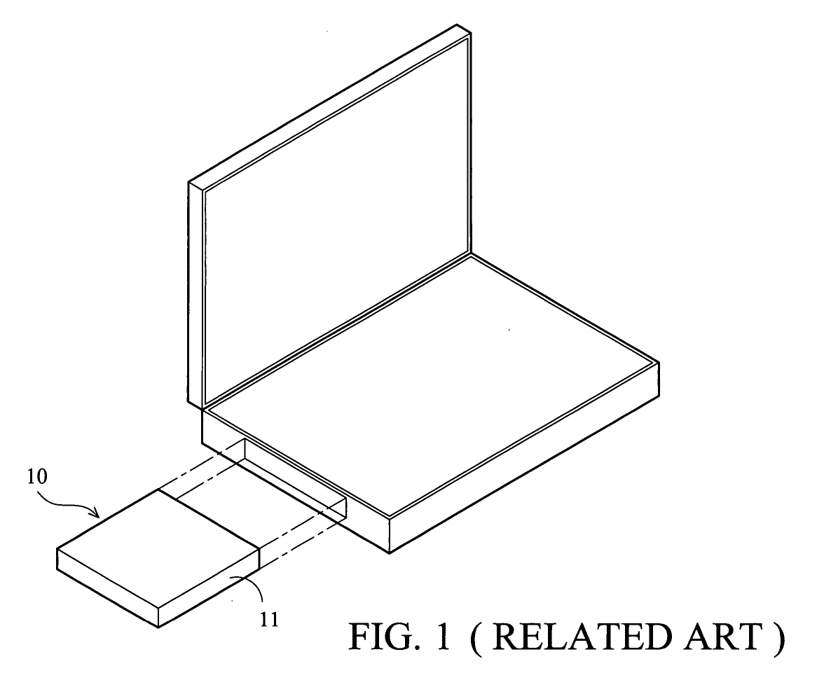

FIG. 2 shows the core of the optical storage drive;

FIG. 3 shows an embodiment of a slim type optical storage drive installed in the notebook computer;

FIG. 4 is a perspective view of an embodiment of the slim type optical storage drive installed in the notebook computer; and

FIG. 5 is a perspective view of another embodiment of a slim type optical storage drive installed in the notebook computer.

### DETAILED DESCRIPTION

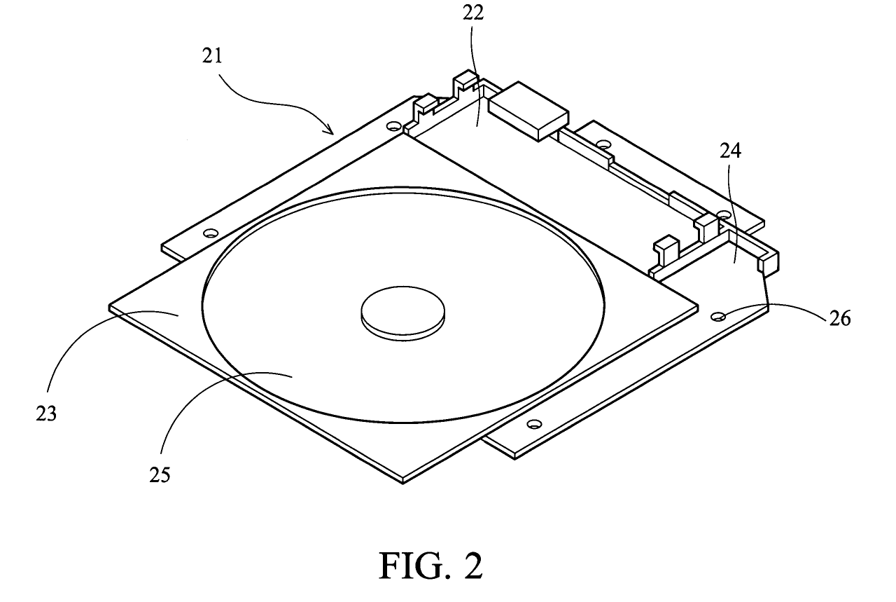

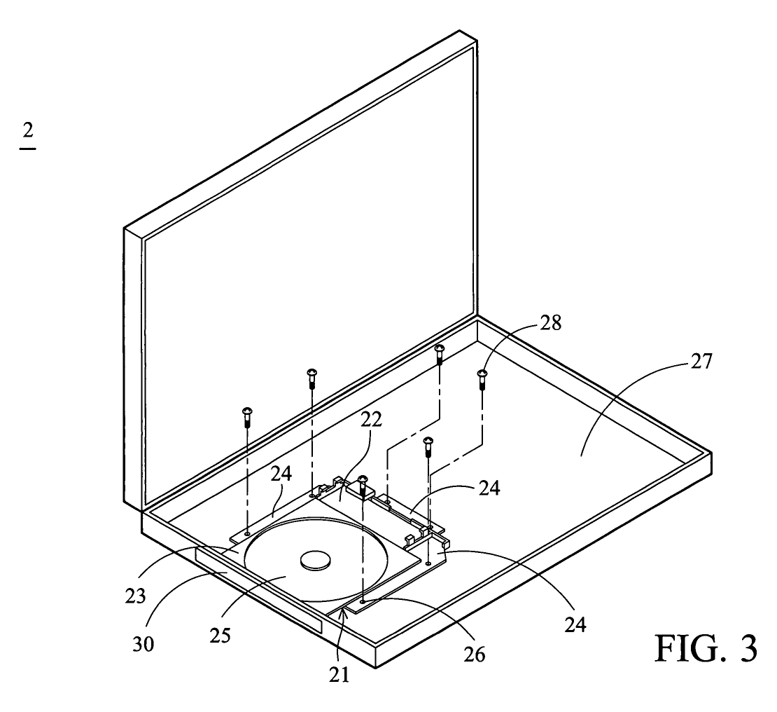

Referring to FIGS. 2 and 3, the core of the optical storage drive 21 has no housing and consisting essentially of a control circuit board 22, a tray 23 and a fixing portion 24. The control circuit board 22 is electrically connected to the notebook computer 2 for driving the optical storage drive. The tray 23 comprises a circular recess 25 for supporting a compact disc or similar optical media. The core of the optical storage drive 21 is installed in the notebook computer 2 via the fixing portion 24 fixed to the bottom board 27 of the notebook computer 2.

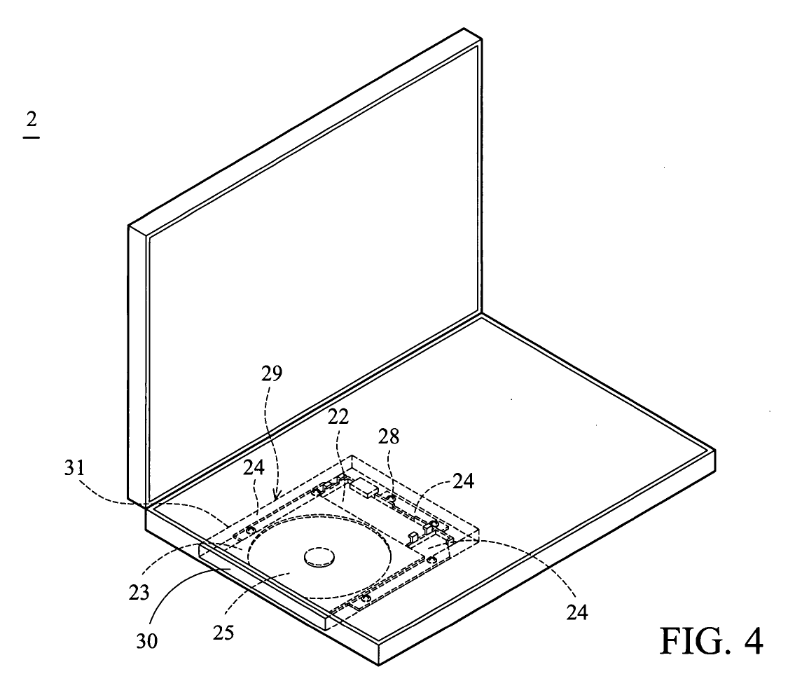

Referring to FIGS. 3 and 4, the fixing portions 24 are preferred three adjacent sides corresponding to the closed side 31 but not the side from which the tray 23 is extracted and retracted. The fixing portion is an extending surface with fixing holes 26 and fixing elements 28 for securing the fixing portion 24 and the notebook computer 2. The notebook computer 2 comprises a space 29 for installing the core of the optical storage drive 21 therein. At least one side around the space 29 is opening side 30, the others are closed sides 31. The closed sides 31 of the notebook computer 2 plays the role of the housing of the conventional optical storage drive for protecting the core of the optical storage drive 21. A notebook computer, provided with a slim type optical storage drive of the invention, is lighter, slimmer, and less costly.

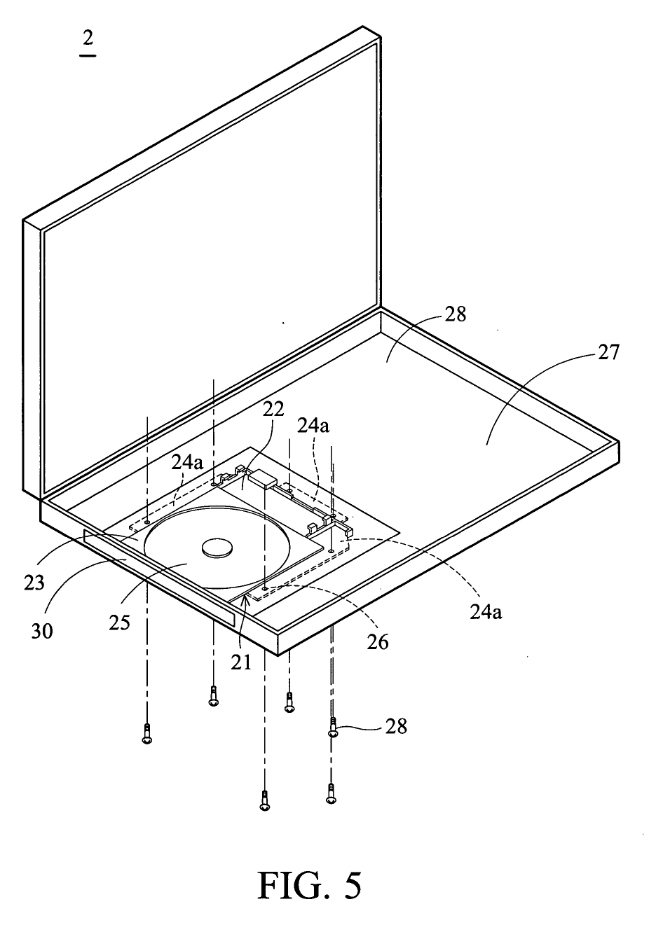

Referring to FIG. 5, the core of the optical storage drive 21 has no housing and comprises a control circuit board 22 and a tray. The bottom board 27 of the notebook computer 2 comprises a fixing area 24a, corresponding to the fixing portions 24 of the optical storage drive 21. The control circuit board 22 is electrically connected to the notebook computer 2 for driving the optical storage drive 21. The tray 23 comprises a circular recess 25 for supporting compact disc. The core of the optical storage drive 21 is installed in the notebook computer 2 via the fixing portion 24a fixing the bottom board 27 of the notebook computer 2.

The fixing area 24a are preferred three adjacent side areas corresponding to the fixing portions 24 but not the side area from which the tray 23 is extracted and retracted. The fixing holes 26 and fixing elements 28 are situated on fixing area 24a for securing the fixing portion 24 and the notebook computer 2. The notebook computer 2 comprises a space 29 for installing the core of the optical storage drive 21 therein. At least one side around the space 29 is opening side 30, the others are closed sides 31. The closed sides 31 replace the housing of the conventional optical storage drive for protecting the core of the optical storage drive 21.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A slim type optical storage drive for a notebook computer, the notebook computer comprising a base and a space with at least a closed side and an open side situated on the base, consisting essentially of:
a core consisting essentially of:
a control circuit board connected electrically to the notebook computer when the core is disposed in the space; and
a tray over the control circuit board for supporting a disc; and
a fixing portion, corresponding to the closed side and connecting between the core and the notebook computer when the core is disposed in the space.

2. The slim type optical storage drive for a notebook computer as claimed in claim 1, wherein the fixing portion is installed on the closed side of the notebook computer, and acts as a part of the base of the notebook computer.

3. The slim type optical storage drive for a notebook computer as claimed in claim 1, wherein the core of the drive further comprises a fastening element for connecting the fixing portion and the base.

4. A notebook computer comprising:
a base;
a space comprising at least a closed side and an open side situated in the base;
a slim type optical storage drive consisting essentially of:
a core, consisting essentially of:
a control circuit board connected electrically to the notebook computer when the core is disposed in the space and
a tray over the control circuit board for supporting a disc; and
a fixing portion installing on the base, corresponding to the closed side of the space, and connecting the core and notebook computer when the core is disposed in the space.
